(19) United States
(12) Patent Application Publication
(10) Pub. No.: US 2006/0085759 A1
(43) Pub. Date: Apr. 20, 2006

(54) User interface display system

(76) Inventor: Claus Knapheide, Philadelphia, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/043,394

(22) Filed: Jan. 25, 2005

Related U.S. Application Data
(60) Provisional application No. 60/619,796, filed on Oct. 18, 2004.

(51) Int. Cl. G06F 17/00

(52) U.S. Cl. 715/777

(57) ABSTRACT

A user interface system for presenting information to a user involves a display processor for initiating generation of data representing an image. The image includes multiple adjacent rows of visible user selectable tabs individually incorporating a tab function identifier identifying a function associated with a respective tab. An individual tab is selectable by a user to initiate presentation of an image area in an image window and presents information concerning a function identified by a tab function identifier of a selected tab. An individual row of visible user selectable tabs includes multiple user selectable tabs together with a non-user selectable label. The non-user selectable label includes information associated with the multiple user selectable tabs on the individual row. A command processor initiates generation of data representing an update of the image to include an image area in an image window and present information concerning a function identified by a tab function identifier of the selected tab in response to user selection of the selected tab.

This is a non-provisional application of provisional application Ser. No. 60/619,796 by C. Knapheide filed Oct. 18, 2004.

### FIELD OF THE INVENTION

This invention concerns a user interface system for providing multiple rows of display elements facilitating identification of available data sources and functions.

### BACKGROUND INFORMATION

Known user interfaces enable a user to navigate multiple display images of different structure and content to locate desired detailed information whilst maintaining context data constant during navigation. Context data comprises parameters such as userid, computer session identifier and data related information, for example. In existing systems, a user navigates multiple display images following a prescribed sequence corresponding to a predetermined user task sequence (workflow) that employs use of different content areas in a particular hierarchy. The navigation hierarchy may involve downward or lateral image navigation. There are a number of known user interface image layouts that support navigation in existing systems. These include blinds, tab cards and node trees.

A blind comprises a menu of rows including an individually selectable image element on each row. An individual image element of a menu row is expandable or collapsible (as another blind) in response to user selection. The location of a blind typically remains stable and visible when another blind within in it is expanded. In existing systems, the value of blinds in facilitating user navigation and orientation is reduced as the number of access points to data increases and the data structure becomes more complex. Further, blinds do not allow for a hierarchical structure of data content as they provide one-dimensional navigation and consequently are best suited to a simple list of data access points.

Tab cards comprise a row of individually selectable image elements (tabs) containing respective identifiers indicating the type of data accessible in response to user selection of a corresponding tab. Upon selection of a tab, data content corresponding to the tab is typically displayed in the foreground of an image adjacent to the tab and obscuring other data e.g., data associated with other tabs. In user interface operation, a user switches between use of tabs and use of the content or available tools. The tabs comprise data access points which remain visible while one of the tabs has been selected.

Node trees also provide user access to information. Node trees comprise branches and sub-branches linking nodes and elements representing data access points in similar fashion to a directory folder, sub-folder representation as exemplified in Windows Explorer. A node tree facilitates hierarchical navigation. However, a node tree uses a relatively large image area and lacks flexibility as well as a capability to readily identify a common relationship between non-hierarchically related data access points. A node tree also fails to provide a visible relation (on a user interface image) of a connection between a tree element and data to be displayed. Navigation (tree) and content are typically displayed in distinct areas of the screen, even though the data belongs together. Further, a position of a given node on an image is arbitrary and needs to be learned in relation to a tree hierarchy, but not in relation to real estate of the screen. A system according to invention principle addresses the identified deficiencies and related problems.

### SUMMARY OF THE INVENTION

User interface data access menus include multi-row blinds incorporating user selectable tabs providing data access points (representing accessible data content) that are repeated on individual blinds, or vary from blind to blind. A user interface system for presenting information to a user involves a display processor for initiating generation of data representing an image. The image includes multiple adjacent rows of visible user selectable tabs individually incorporating a tab function (or data source) identifier identifying a function (or type of data) associated with a respective tab. An individual tab is selectable by a user to initiate presentation of an image area in an image window and presents information concerning a function identified by a tab function identifier of a selected tab. An individual row of visible user selectable tabs includes multiple user selectable tabs together with a non-user selectable label. The non-user selectable label includes information associated with the multiple user selectable tabs on the individual row. A command processor initiates generation of data representing an update of the image to include an image area in an image window and present information concerning a function identified by a tab function identifier of the selected tab in response to user selection of the selected tab.

### BRIEF DESCRIPTION OF THE DRAWING

FIG. 1 shows a user interface data access menu including multi-row tabbed blinds, according to invention principles.

FIG. 2 shows a networked hospital information system employing user interface data access menus including multi-row blinds incorporating user selectable tabs, according to invention principles.

FIG. 3 illustrates characteristics of the user interface data access menu of FIG. 1, according to invention principles.

FIG. 4 shows a user interface data access menu including multi-row tabbed blinds that are closed, according to invention principles.

FIG. 5 shows a flowchart of a process for providing a user interface data access menu including multi-row tabbed blinds, according to invention principles.

### DETAILED DESCRIPTION OF INVENTION

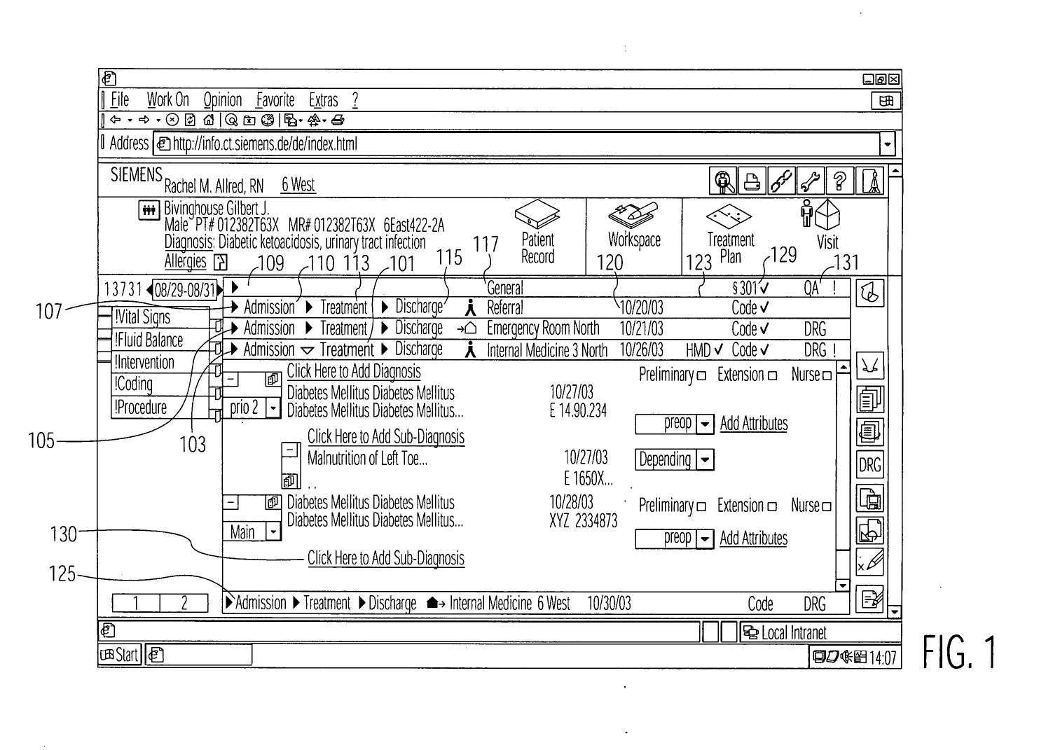

FIG. 1 shows a user interface data access menu advantageously including multi-row tabbed blinds and indicating a single blind tab is open and the remaining blind tabs are closed. Specifically, the menu shows four rows of tabbed blinds 103, 105, 107 and 109 with a single tab 101 open in the blind of row 103. The user selectable tabs in columns 110, 113 and 115 individually incorporate a tab function or data content type identifier identifying a function or data content associated with a respective tab. A blind as used herein comprises a menu of one or more rows and one row includes multiple blinds. Blinds are represented by a row of tabs plus identifier including an individually selectable image element on each row. In response to user selection of an image element of an individual menu row, the blind row expands to provide an adjacent image area including data content associated with the selected image element. Similarly, an expanded image area is collapsed in response to user selection of the currently selected image element of the individual menu row. The menu of multi-row tabbed blinds provides different tabs or sections on individual blinds thereby providing user selectable tabs in a grid structure. The different tabs may provide access to correspondingly different types of information or may provide access to types of information having a common relationship. In response to user selection of a tab (e.g., tab 101) in one of the rows of tabbed blinds 103, 105, 107 and 109, associated information is displayed in image area 130. Upon user selection of another tab in one of the rows of tabbed blinds 103, 105, 107 and 109, image area 130 updates with corresponding associated information.

A tab function identifier as used herein identifies a function associated with a respective tab or type of data content presented in an image area in response to selection of a particular tab. An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable application or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

Known user interface elements facilitating user access to desired data include tab cards. A tab card comprises a row of individually selectable image elements (tabs) containing respective identifiers indicating the type of data accessible in response to user selection of a corresponding tab. The inventor has advantageously recognized that, although users readily adapt to using a tab card comprising a single row of tabs, users often find stacked tab cards in multiple rows to be confusing. Such stacked tab cards fail to provide a user friendly interface and fail to promote comprehension. However, multiple rows of tab cards increase the number of user selectable tabs and are able to present a hierarchical data access structure. Further, multiple rows of tab cards may be arranged so that elements in the same horizontal row are more closely related than elements on different rows. The inventor has advantageously also recognized that multiple rows of tab cards are deemed to be confusing by users because a tab and its row change position and jump to the front upon user selection. This is exemplified in the current version of Microsoft Word in the multiple tab cards of the Tools menu and Options selection. This tab re-location impedes user navigation as well as recollection and tracking of those tabs that the user has already activated and results in the user losing context. Existing multiple tab card menu interfaces rely on change of position and row change of a user selected tab in order to ensure a selected tab is adjacent to an image area showing the data content associated with the selected tab.

In contrast, in response to user selection of tab 101 in row 103 of the multi-row tabbed blind menu of FIG. 1, selected tab 101 maintains its existing position and does not re-locate. Further, the multi-row tabbed blind menu ensures selected tab 101 remains stationary and adjacent to image area 130 that shows the data content associated with selected tab 101. It does this because the selected row acts as a blind so that next subsequent tabbed row 125 re-locates instead and moves to accommodate the image area showing the data content associated with the selected tab. Data content image area 130 occupies a position between selected tab row 103 and re-located next subsequent row 125. This advantageously reduces user confusion and provides a more user friendly interface for data access navigation. When a tab on row 109 is open, four rows 107, 105, 103 and 125 are below an expanded image area adjacent to row 109. Similarly, when a tab on row 107 is open, row 109 is above, and three rows 105, 103 and 125 are below, an expanded image area adjacent to row 107. Also, when a tab on row 105 is open, rows 109 and 107 are above, and two rows 103 and 125 are below, an expanded image area adjacent to row 105. Further, when a tab on row 125 is open, rows 109, 107, 105 and 103 are above, an expanded image area adjacent to row 125. The multi-row tabbed blind menu enables user navigation and access to data structured in complex relationships whilst concurrently providing a user with an overview of the structure and detailed information concerning the accessible data.

An individual row of multiple tabs in columns 110, 113 and 115 of the multi-row tabbed blind menu advantageously includes a non-user selectable label in column 117. The non-user selectable label includes information associated with the multiple user selectable tabs on the individual row. The label in a particular row in column 17 may identify an attribute common to the data accessed via tabs on the particular row and differentiate the type of data accessed via these tabs from data accessed via tabs on other rows of the multi-row tabbed menu. The label in a particular row in column 17 may also identify an attribute common to a function initiated via tabs (or an attribute common to data accessed via the tabs) on the particular row and differentiate the function initiated via these tabs from functions initiated via tabs on other rows of the multi-row tabbed menu. In another embodiment, columns (e.g., 110, 113 and 115) of tabs (access points) may also be labeled. This is particularly useful where tabs of an individual column are used to access data having common characteristics. In such an embodiment, the columns are labeled and the rows may or may not be labeled. Further, in another embodiment the display image area (e.g., image area 130) for the display of data content associated with a selected tab opens vertically in contrast to the horizontal opening of area 130 indicated in FIG. 1.

Different rows may employ the same tab function identifiers and the functions (or types of data accessed) by the associated tabs is differentiated by different labels in column 17 of the different rows. Alternatively, different rows may employ the same labels in column 17 and the functions (or types of data accessed) by the associated tabs is differentiated by different tab function identifiers. An individual row of multiple tabs in columns 110, 113 and 115 of the multi-row tabbed blind menu includes other non-user selectable attributes or labels in columns 120, 123, 129 and 131. The tab function identifier (Treatment) of selected tab 101 is associated with a Subvisit labeled ‘Internal Medicine 3 North’ in column 117. The other blinds and tabs are closed as one tab is allowed to be open at a time. In another embodiment, it is possible for multiple tabs on the same row to be open at the same time, in which case associated data content is displayed in multiple adjacent corresponding image areas such as multiple sub-divided areas of area 130.

The multi-row tabbed menu advantageously combines the positional stability of a blind (i.e., a selected blind row remains stationary) with efficient use of display image area and an ability to group tabs comprising data access points in a hierarchical structure. Thereby a user experiences improved orientation (awareness of current location) within a user interface data structure and improved navigation and ability to find desired information. The multi-row tabbed menu enables a user to concurrently view multiple tabs (data access points) permitting access to information whilst one of the tabs (e.g., tab 101) is in selected condition and adjacent image area 130 (presenting data content associated with selected tab 101) is also concurrently displayed. Additional data content areas related to data accessed via tab 101 are accessible by user selection of a tabs in row 103 in columns 110 and 115 to the left and right of tab 101. Further, in a multi-row tabbed menu several rows of tabs may be provided above and below an expanded image area presenting data content associated with a selected tab. The multi-row tabbed menu facilitates user navigation from tab to tab (data access point to data access point) without losing orientation in contrast to navigation using multi-row tab cards employed in existing user interfaces. The multi-row tabbed menu readily indicates to a user that different tabs or rows of tabs represent, and facilitate access to, different types of information that may be repetitive or unique.

The multi-row tabbed menu is also usable to facilitate association and user access to different types of information such as different versions or instances of information. The multi-row tabbed menu grid like structure is usable to identify to a user that first information is accessed for a first instance of a data access point and second information is accessed for a second instance of a data access point, for example. Tabs in a particular row of a multi-row tabbed menu may be used to access similar types of information while tabs in a different row are used to access entirely different types of information. Row 109 is used to access an entirely different type of information from rows 103, 105, 107 and 125, for example. Specifically, row 109 comprises a single traditional blind (with identifier—General) without additional user selectable tabs. The label (General) on row 109 appearing in column 117 is different to the other labels of rows 125, 103, 105 and 107 in column 117 in that it is a tab identifier and is user selectable. The other rows 107, 105, 103 and 125 are blind/tab combination with rows individually containing multiple tabs with identifiers Admission, Treatment, Discharge together with labels, Referral, Emergency Room North, Internal Medicine 3 North and Internal Medicine 6 West respectively. Tab 101 on row 103 (with identifier Treatment) of row labeled Internal Medicine 3 North is currently open as indicated by a visual display attribute comprising a distinguishing white font in this example. Further, a user is able to review and edit data content presented in an image area adjacent to a selected tab as well as to navigate horizontally to another tab on the same row, or to navigate vertically to a tab in the same column of another row or to any other access point.

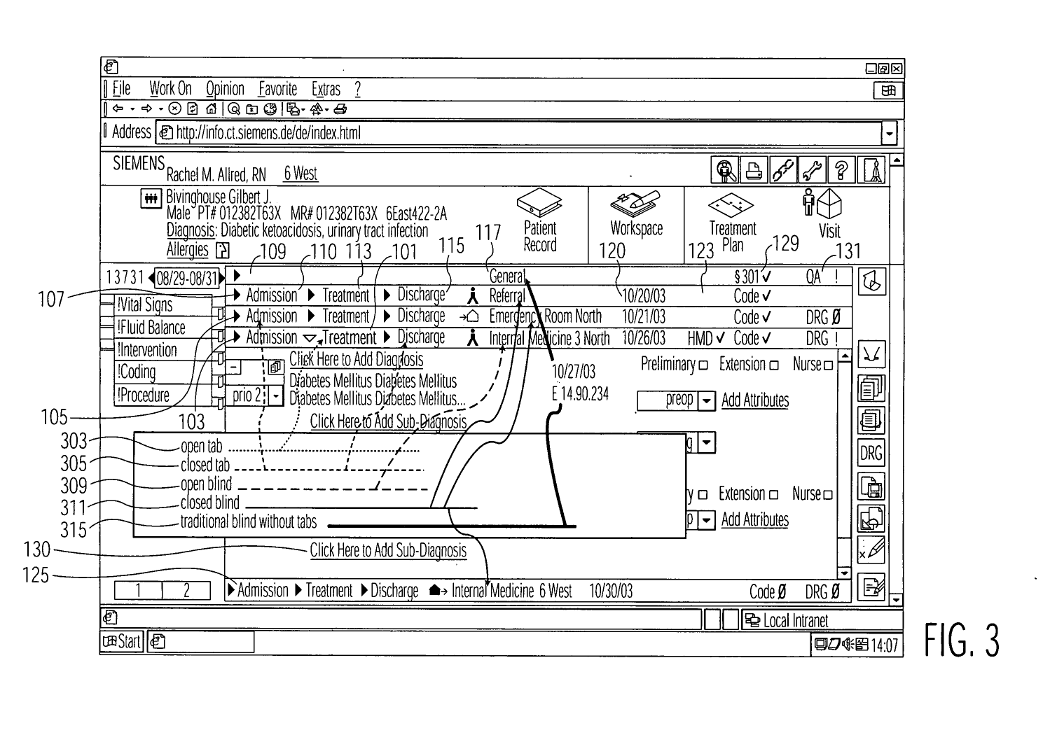

FIG. 3 illustrates characteristics of the user interface data access menu of FIG. 1. Items 303 and 305 indicate open tab 101 and closed tabs respectively. Items 309, 311 and 315 indicate an open row (blind) 103, closed rows (blinds) 105, 107 and 125 and a traditional row (blind) 109 without additional user selectable tabs, respectively.

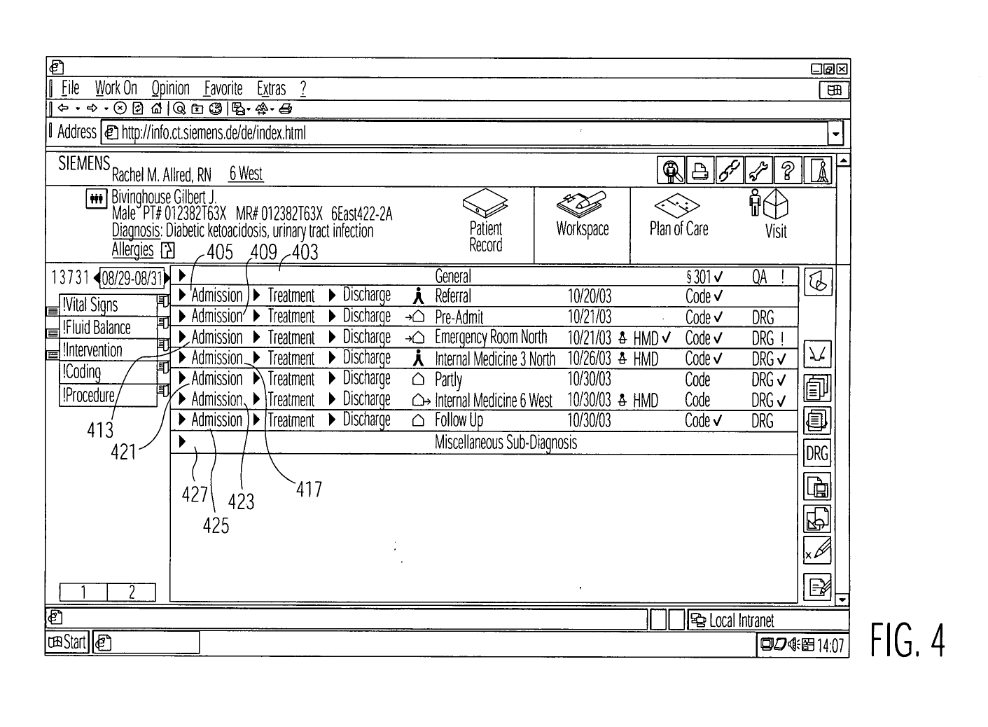

FIG. 4 shows a user interface data access menu including multi-row tabbed blinds that are closed. The user selectable menu tabs are in unselected condition so that no data content image area is open. The multi-row tabbed menu indicates hierarchical relationships between data access points (tabs) and associated accessible data content. A user is able to access admission, treatment or discharge information indicated on seven rows 405-425 for any of seven encounters of a patient with a healthcare provider organization. A user is also able to use the multi-row tabbed menu to access a tab on row (blind) 403 (identified as General) or to access a tab on row (blind) 427 (identified as Miscellaneous Sub-Diagnosis). The Miscellaneous blind of row 427 enables access to data concerning another type of encounter but the accessible data does not fit the structure of Admission, Treatment or Discharge. A user is able to initiate performance of a sequence of tasks (a workflow) involved in delivering healthcare to a patient using information derived from the displayed multi-row tabbed menu data structure indicating the presence of Admission, Treatment or Discharge for the seven separate occasions prior to even accessing the detailed information via the displayed tabs. This is because the hierarchical data structure itself reveals valuable information supporting performance of a user workflow. Further, if a user selects a tab to initiate viewing of specific data content concerning a first Treatment provided during a first encounter (visit), other tabs (data access points) remain visible.

The user is able to navigate the multi-row tabbed menu of FIGS. 1 and 4 vertically to compare the first treatment information of the first encounter with information concerning a second treatment of a second different encounter. The user is also able to navigate the multi-row tabbed menu horizontally to access and review discharge information of the first encounter and is also able to randomly access other encounter information. The multi-row tabbed menu maintains an overview of a structure of accessible data whilst presenting particular accessed data in response to user selection of a tab. The overview is displayed prior to accessing data via a tab and whilst detail data is being displayed in response to user selection of a tab. The multi-row tabbed menu facilitates user understanding of a matrix relationship between data access points and associated data content. The multi-row tabbed menu offers increased density of data access points by providing tabs in a grid structure with a non-user selectable label on individual rows. This structure advantageously indicates a hierarchical relationship between data access points and enables use of a duplicate tab (and tab identifier) for accessing similar (or the same) types of information on different rows. The different rows are distinguished by different corresponding labels in column 117 (FIG. 1) that identify to the user the differences in the data accessible via the identically labeled tabs on the different rows.

A minimum display image area for image area 130 is predetermined for the display of data content associated with a selected tab (e.g., tab 101) upon expansion of the multi-row tabbed menu. The user interface system maintains a predetermined ratio between the multi-row tabbed menu navigation image area and the display image area (e.g., image area 130) for the display of data content associated with a selected tab. In another embodiment a variable ratio may be employed.

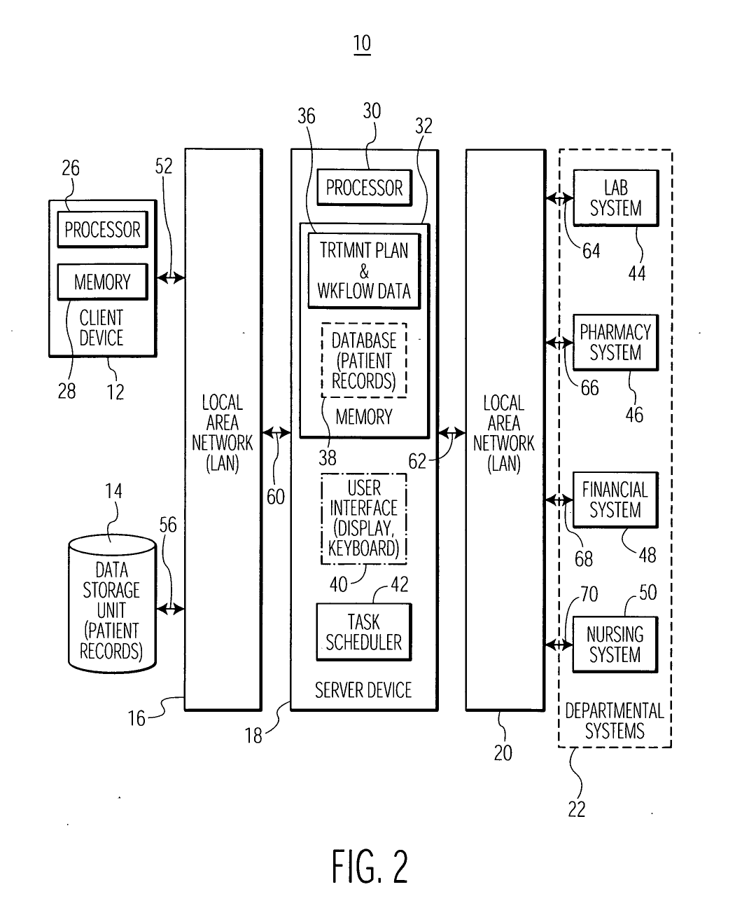

FIG. 2 shows a networked hospital information system employing user interface data access menus including multi-row blinds incorporating user selectable tabs. Healthcare information system 10 includes a client device 12, a data storage unit 14, a first local area network (LAN) 16, a server device 18, a second local area network (LAN) 20, and departmental systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

User interface system 40 provides the multi-row tabbed menus of FIGS. 1 and 4 and is located in server 18. Server device 18 permits multiple users to employ multi-row tabbed menus at multiple client devices. In another embodiment user interface system 40 is located in client device 12. User interface system 40 includes an input device that permits a user to provide information to client device 12 and an output device that provides a user a display of the multi-row tabbed menus and other information. Preferably, the input device is a keyboard and mouse, but also may be a touch screen or a microphone with a voice recognition program, for example. The output device is a display, but also may be a speaker, for example. The output device provides information to the user responsive to the input device receiving information from the user or responsive to other activity by client device 12. For example, the display presents information responsive to the user entering information in the client device 12 via a keyboard.

Server device 18 generally includes processor 30, a memory unit 32 including workflow data and a treatment plan 36 and a database 38 containing patient records. Server device 18 also includes Rules Engine and Workflow Engine (task scheduler 42). Server device 18 is may be implemented as a personal computer or a workstation. Database 38 provides a location for storing patient records and data storage unit 14 provides an alternate store for patient records, as well as other information for hospital information system 10. The information in data storage unit 14 and database 38 is accessed by multiple users from multiple client devices in response to user selection of tabs in multi-row tabbed menus. Alternatively, patient records may be accessed from memory unit 28 in client device 12, or in memory units in the departmental systems 22. Patient records in data storage unit 14 include information related to a patient including, without limitation, biographical, financial, clinical, workflow, care plan and patient encounter (visit) related information.

In response to user selection of tabs collated in multi-row tabbed menus (e.g. as shown in FIG. 1), a user is able to access patient records for multiple encounters with similar types of information such as Admission, Treatment and Discharge information concerning diagnoses, procedures, problems, orders and medication, for example. Particular encounter (visit) or sub-encounter (subvisit) types are associated with particular types of records. For example, pre-admission encounters do not give rise to records concerning problems or diagnoses and follow-up encounters do not give rise to records concerning procedures. Also referral sub-encounters or general sub-encounters do not give rise to records concerning diagnoses, procedures, problems, orders or medication. A clinical user viewing the multi-row tabbed menus is readily able to determine common characteristics in records of a list of sub-encounters. Further, multiple different persons may be associated with a patient account including, a guarantor, a related patient (e.g., mother and child) and other relatives. A multi-row tabbed menu is advantageously able to indicate similar kinds of information may or may not need to be acquired or accessed for these associated persons. Such similar kinds of information include, contact information, description of relation to patient, consent documents, signatures (not necessarily for relatives), history information (not necessarily for relatives) or prior communications (such as letters), for example. An administrator may use the multi-row tabbed menu to access similar kinds of information to check accuracy of billing.

A multi-row tabbed menu advantageously enables a clinical user to compare data accessed in response to user selection of tabs horizontally or vertically in a menu. Further, a user may need to enter or edit information for storage in one or more of the information sources accessed by the tabs via the multi-row tabbed menu. A configuration and authorization function within processor 30 (FIG. 2) determines whether a user is authorized to enter information concerning Admission for one or more sub-encounters, for example. A user employs a multi-row tabbed menu to access patient record information from databases 14 and 38 and departmental systems 22 in a variety of file formats including, text files such as documents, graphic files including, for example, an electrocardiogram (EKG) trace, an electrocardiagram (ECG) trace, and an electroencephologram (EEG) trace, video files such as a still video image or a video image sequence, an audio file such as an audio sound or an audio segment, and visual files, such as a diagnostic image including, for example, a magnetic resonance image (MRI), an x-ray, a positron emission tomagraphy (PET) scan, or a sonogram. The accessed patient record information also includes clinician summaries, notes, investigations, orders, medications, correspondence, results, etc.

The first local area network (LAN) 16 (FIG. 2) provides a communication network among the client device 12, the data storage unit 14 and the server device 18. The second local area network (LAN) 20 provides a communication network between the server device 18 and the departmental systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN).

The communication paths 52, 56, 60, 62, 64, 66, 68 and 70 permit the various elements, shown in FIG. 2, to communicate with the first LAN 16 or the second LAN 20. Each of the communication paths 52, 56, 60, 62, 64, 66, 68 and 70 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

The I.P. data format, otherwise called an I.P. protocol, uses IP addresses. Examples of the I.P. addresses include, without limitation, Transmission Control Protocol Internet Protocol (TCPIP) address, an I.P. address, a Universal Resource Locator (URL), and an electronic mail (Email) address. The communication paths 52, 56, 60, 62, 64, 66, 68 and 70 each may be formed as a wired or wireless (W/WL) connection. The wireless connection permits a person using the healthcare information system 10 to be mobile beyond the distance permitted with a wired connection.

Departmental systems 22 are systems that need access to information or provide information related to the health and/or welfare of patients in the care of the healthcare provider. Examples of the departmental systems 22 include, a lab system 44, a pharmacy system 46, a financial system 48 and a nursing system 50, as shown in FIG. 2, but may also include a records system, a radiology system, an accounting system, a billing system, and any other system required or desired in a healthcare information system.

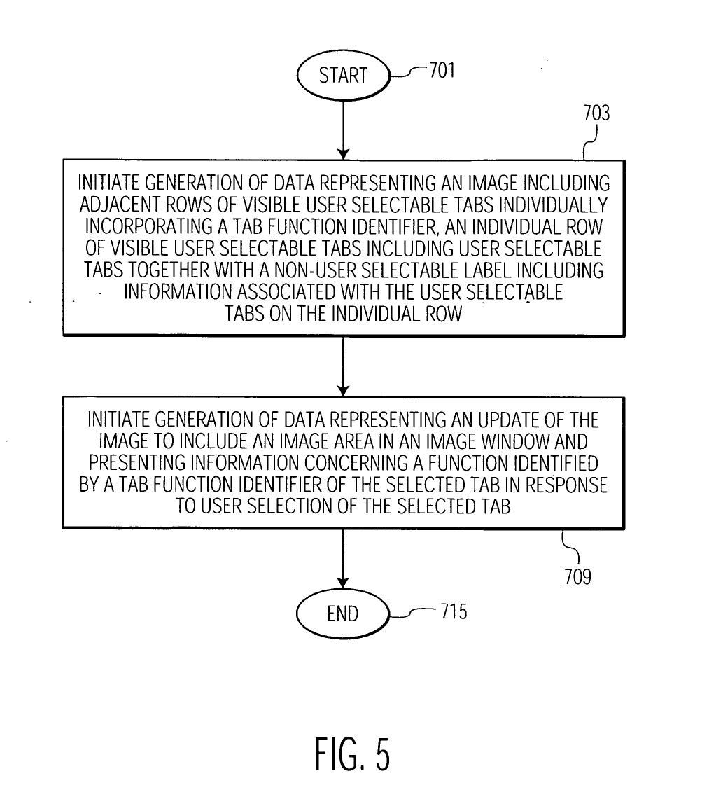

FIG. 5 shows a flowchart of a process performed by display and command processors comprising user interface system 40 in conjunction with processor 30 (FIG. 2) for providing a user interface data access menu including multi-row tabbed blinds. In Step 703 following the start at step 701, system 40 (in conjunction with processor 30) initiates generation of data representing an image including multiple adjacent rows of visible user selectable tabs comprising a matrix of user selectable tabs individually incorporating a tab function identifier identifying a function associated with a respective tab. An individual tab is selectable by a user to initiate presentation of an image area in an image window adjacent to a selected tab and presenting information concerning a function identified by a tab function identifier of the selected tab. An individual row of visible user selectable tabs includes multiple user selectable tabs together with a non-user selectable label. The non-user selectable label includes information associated with the multiple user selectable tabs on the individual row and comprises one or more of, text, characters and symbols. In one embodiment, user selectable tabs on different rows of the multiple adjacent rows contain the same tab function identifier and are differentiated in function by different non-user selectable labels on the different rows. A tab function identifier includes a text portion as well as a selection identifier indicating a tab is in a selected or non-selected state.

The tab function identifier identifies at least one of, a function associated with a respective tab and type of data content presented in the image area in the image window in response to selection of the selected tab. In one embodiment, a particular visible tab is associated with a particular universal resource locator (URL) and the image window presents web page information in response to user selection of the particular visible tab. The selection identifier comprises one or more of, an icon separate from the tab function identifier and a characteristic of the tab function identifier. The characteristic of the tab function identifier comprises at least one of, color, shading, shape, highlighting, background color and text. System 40 in conjunction with processor 30 in step 709, initiates generation of data representing an update of the image to include an image area in an image window. The image area presents information concerning a function (or particular type of data) identified by a tab function (or type of data) identifier of the selected tab in response to user selection of the selected tab. A configuration processor in response to user command initiates display of command menu items supporting at least one function of, ordering tabs and entering identifier data for incorporation in a visible tab. The process of FIG. 5 terminates at step 715. Memory 32 of FIG. 2 incorporates a tangible storage medium (e.g., a disk or RAM) incorporating machine readable instruction executable by user interface system 40 in conjunction with processor 30 for performing the process of FIG. 5.

The system, processes and user interface menus presented in FIGS. 1-5 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIG. 2 and process shown in FIG. 5 may be implemented in hardware, software or a combination of both. The system is usable wherever related information elements need to be accessed and displayed in response to user selection of tabs in a matrix format. For example, in management of bank accounts, a user may have accounts with multiple different banks (accessed via tabs in adjacent horizontal rows with one row per bank) with individual tabs for accessing information associated with Checking, Savings and Credit Card on individual rows for each bank. A multi-row tabbed menu readily indicates to a user those accounts that have an associated credit card and those accounts that do not and the user is able to recognize account features and navigate even without knowing account number or a name of bank in many cases. A multi-row tabbed menu is similarly advantageously usable in a variety of other applications such as for example, in management of vehicle information within a family where one row of tabs is used per car and individual tabs are used for insurance, maintenance and credit information.

What is claimed is:

1. A user interface system for presenting information to a user, comprising:
a display processor for initiating generation of data representing an image, said image including,
a plurality of adjacent rows of visible user selectable tabs individually incorporating a tab function identifier identifying a function associated with a respective tab, an individual tab being selectable by a user to initiate presentation of an image area in an image window and presenting information concerning a function identified by a tab function identifier of a selected tab, an individual row of visible user selectable tabs including a plurality of user selectable tabs together with a non-user selectable label, said non-user selectable label including information associated with said plurality of user selectable tabs on said individual row; and
a command processor for initiating generation of data representing an update of said image to include an image area in an image window and presenting information concerning a function identified by a tab function identifier of said selected tab in response to user selection of said selected tab.

2. A system according to claim 1, wherein
said image window comprises an image area adjacent to said selected tab.

3. A system according to claim 1, wherein
said plurality of adjacent rows of visible user selectable tabs remain present in response to update of said image to include said image area in said image window presenting information concerning said function identified by said tab function identifier of said selected tab in response to user selection of said selected tab.

4. A system according to claim 1, wherein
a tab function identifier includes a selection identifier indicating a tab is in at least one of, (a) selected and (b) non-selected state.

5. A system according to claim 4, wherein
said selection identifier comprises at least one of, (a) an icon separate from said tab function identifier and (b) a characteristic of said tab function identifier.

6. A system according to claim 5, wherein
said characteristic of said tab function identifier comprises at least one of, (a) color, (b) shading, (c) shape, (d) highlighting, (e) background color and (f) text.

7. A system according to claim 1, wherein
said tab function identifier comprises text.

8. A system according to claim 1, wherein
user selectable tabs on different rows of said plurality of adjacent rows contain the same tab function identifier and are differentiated in function by different non-user selectable labels on said different rows.

9. A system according to claim 1, wherein
said plurality of adjacent rows of visible user selectable tabs comprise a matrix of user selectable tabs.

10. A system according to claim 1, wherein
said tab function identifier identifies at least one of, (a) a function associated with a respective tab and (b) type of data content presented in said image area in said image window in response to selection of said selected tab.

11. A system according to claim 1, wherein
said non-user selectable label comprises at least one of, (a) text, (b) characters and (c) symbols.

12. A user interface system for presenting information to a user, comprising:
a display processor for initiating generation of data representing an image, said image including,
a plurality of adjacent rows of visible user selectable tabs individually incorporating a tab identifier identifying a type of data associated with a respective tab, an individual tab being selectable by a user to initiate presentation of an image area adjacent to a selected tab and presenting said type of data identified by said tab identifier of said selected tab, an individual row of visible user selectable tabs including a plurality of user selectable tabs together with a non-user selectable label, said non-user selectable label including information associated with said plurality of user selectable tabs on said individual row; and
a command processor for initiating generation of data representing an update of said image to include an image area adjacent to a selected tab and presenting said type of data identified by a tab function identifier of said selected tab in response to user selection of said selected tab.

13. A user interface system for presenting information to a user, comprising:
a display processor for initiating generation of data representing an image, said image including,
a plurality of adjacent columns of visible user selectable tabs individually incorporating a tab function identifier identifying a function associated with a respective tab, an individual tab being selectable by a user to initiate presentation of an image area adjacent to a selected tab and presenting information concerning a function identified by a tab function identifier of a selected tab, an individual column of visible user selectable tabs including a plurality of user selectable tabs together with a non-user selectable label, said non-user selectable label including information associated with said plurality of user selectable tabs on said individual column; and
a command processor for initiating generation of data representing an update of said image to include an image area adjacent to a selected tab and presenting information concerning a function identified by a tab function identifier of said selected tab in response to user selection of said selected tab.

14. A method for providing a user interface display presenting information to a user, comprising the activities of:
initiating generation of data representing an image, said image including,
a plurality of adjacent rows of visible user selectable tabs individually incorporating a tab function identifier identifying a function associated with a respective tab, an individual tab being selectable by a user to initiate presentation of an image area in an image window and presenting information concerning a function identified by a tab function identifier of a selected tab, an individual row of visible user selectable tabs including a plurality of user selectable tabs together with a non-user selectable label, said non-user selectable label including information associated with said plurality of user selectable tabs on said individual row; and
initiating generation of data representing an update of said image to include an image area in an image window and presenting information concerning a function identified by a tab function identifier of said selected tab in response to user selection of said selected tab.

15. A tangible storage medium incorporating machine readable instruction for performing the activities of claim 14.

16. A method according to claim 14, including the step of
initiating display of command menu items supporting at least one function of, (a) ordering tabs and (b) entering identifier data for incorporation in a visible tab.

17. A method according to claim 14, wherein
a particular visible tab is associated with a particular universal resource locator (URL) and
said image window presents web page information in response to user selection of said particular visible tab.
